(19) United States
(12) Patent Application Publication
(10) Pub. No.: US 2018/0017414 A1
(43) Pub. Date: Jan. 18, 2018

(54) DATA LOGGER

(71) Applicant: Testo SE & Co. KGaA, Lenzkirch (DE)

(72) Inventors: Jorg Binder, Friedenweiler (DE); Tobias Faisst, Freiburg (DE)

(73) Assignee: Testo SE & Co. KGaA, Lenzkirch (DE)

(21) Appl. No.: 15/648,786

(22) Filed: Jul. 13, 2017

(30) Foreign Application Priority Data
Jul. 15, 2016 (DE) 102016008517.7

(51) Int. Cl. G01D 9/00

(52) U.S. Cl. CPC G01D 9/00

(57) ABSTRACT

In a data logger (1) it is provided to couple in a detachable fashion to one another an electronic housing part (7) which accommodates an electronic part (2) embodied with a sensor signal-processing device (4) and at least one measuring sensor (5), to a battery housing part (8) which accommodates a battery (6) for supplying the sensor signal-processing device (4), wherein in the coupled state an electrical connection between the battery (6) and the sensor signal-processing device (4) is established via contacts (12) and corresponding mating contacts (13), and in the uncoupled state it is disconnected, and wherein in the coupled state a seal (10) on the coupling (9) protects the contacts (12) and the mating contacts (13) with respect to the outside.

### INCORPORATION BY REFERENCE

The following documents are incorporated herein by reference as if fully set forth: German Patent Application No. 102016008517.7, filed Jul. 15, 2016.

### BACKGROUND

The invention relates to a data logger having an electronic part and a battery part, wherein the electronic part has a sensor signal-processing device and a measuring sensor connected thereto, and the battery part has a battery for supplying at least the sensor signal-processing device, wherein the electronic part is arranged in an electronic housing part, and the battery part is arranged in a battery housing part.

Such data loggers are known and are used, for example, for recording a physical measurement variable under tough conditions over a time profile.

In such uses there is always the problem that the data logger has to be sealed. On the other hand, there is the desire to exchange the battery easily when it is flat.

### SUMMARY

The invention is therefore based on the object of making available a data logger with improved use properties.

This is addressed using one or more features according to the invention. Therefore, in order to solve the stated problem, according to the invention it is provided in a data logger of the type described at the beginning that the battery housing part can be detachably connected to the electronic housing part via a coupling, wherein a seal is formed on the coupling, by which seal a contact region is sealed with respect to the outside with contacts of the electronic part and corresponding mating contacts of the battery part in the coupled state of the coupling, and wherein in the uncoupled state of the coupling the contacts are electrically isolated from the corresponding mating contacts. Therefore, the invention is to provide a data logger in which the battery can be exchanged easily and, in particular, without a tool and which can simultaneously satisfy stringent requirements of the seal of the housing. This improves the use properties significantly.

In one advantageous refinement there is provision that the coupling can be coupled and/or uncoupled by a relative movement of the electronic housing part with respect to the battery housing part. Therefore, a single connection and/or disconnection of the electronic part and battery part are/is made possible. A coupling can be formed with the smallest possible space requirement transversely with respect to a longitudinal direction of the data logger.

In one advantageous refinement there is provision that the coupling has a guide with which the relative movement is defined. Therefore, satisfactory coupling can be checked by the user without visual inspection being absolutely necessary.

In one advantageous refinement there is provision that the relative movement is a turning movement, plug-in movement, screwing movement or plug-in and turning movement. Therefore, coupling movements and disconnecting movements which are easy to execute can be implemented.

In one advantageous refinement there is provision that in the coupled state the coupling is secured against unintentional opening. Therefore, the battery part can be attached in a captive fashion to the electronic part.

In one advantageous refinement there is provision that the coupling has a bayonet closure. The coupling can therefore be secured mechanically against unintentional opening.

In one advantageous refinement there is provision that the coupling is embodied as a magnetic coupling. The coupling can therefore be secured in a wear-free state against unintentional opening.

In one advantageous refinement there is provision that the contacts and/or the corresponding mating contacts are embodied symmetrically in such a way that there is electrical contact over a section of the relative movement and/or in a plurality of orientations of the electronic housing part with respect to the battery housing part. Therefore, electrical contact can already be established even when the coupling is not coupled completely. The connectability of the electronic housing part to the battery housing part in a plurality of orientations has the advantage that the user does not have to laboriously search for and check the correct orientation for the joining of the housing parts, for example by laborious visual inspection.

In one advantageous refinement there is provision that a sensor tip is formed on the electronic housing part, in which sensor tip the at least one measuring sensor is arranged. Therefore the measuring sensor can be accommodated integrally in the electronic housing part and, if appropriate, can be encapsulated with the electronic housing part.

In one advantageous refinement there is provision that the measuring sensor is a temperature sensor and/or a pressure sensor. It is advantageous here that regular temperature monitoring and/or regular pressure monitoring can be carried out with the data logger.

In one advantageous refinement there is provision that the contacts are arranged on an underside of a printed circuit board. It is advantageous here that it is possible to make contact directly with the printed circuit board which supports the sensor signal-processing device or parts thereof. Additional cabling can therefore be dispensed with. In addition, the formation of contact with a printed circuit board which supports the contacts provides the advantage that the formation of contact can be established easily during the plugging together or joining. It is particularly favorable here if the sensor signal-processing device is arranged on an upper side of the printed circuit board. Therefore, a space-saving and/or material-saving configuration can be achieved. The printed circuit board is preferably inserted into the electronic housing part. It can therefore easily be ensured that the contact can be formed with the printed circuit board when the coupling is connected.

In one advantageous refinement there is provision that the battery is arranged in the battery housing part encapsulated in such a way that it is inaccessible with respect to the outside. Therefore, a separate battery part can be formed in which the battery is arranged in a protected fashion independently of the state of the coupling. It is particularly favorable here if the battery is encapsulated by a coupling part of the coupling. Therefore, a battery part can be provided which is easy to manufacture and in which the battery can be inserted, for example, into the battery housing part and closed off by the coupling part.

In one advantageous refinement there is provision that in the coupled state the electronic housing part and the battery housing part at least encapsulate the sensor signal-processing device. This can provide sealed storage of the sensor signal-processing device in the coupled state.

In one advantageous refinement there is provision that the electronic housing part is fabricated from metal. A robust housing part can therefore be fabricated.

In one advantageous refinement there is provision that the battery housing part is fabricated from plastic. Therefore, the battery part can be manufactured cost-effectively as a disposable part.

In one advantageous refinement there is provision that the seal is a sealing ring. Therefore, a geometrically simple interface can be formed which can be sealed with little effort. The use of planar sealing ring is particularly advantageous for the described relative movements which distinguish a plug-in and/or rotational axis. The sealing ring is preferably of planar design and therefore extends, for example, completely in one plane. The formation of a planar sealing ring has the advantage that in the coupled state a seal can easily be achieved if, for example, the relative movement is a turning movement, plugging-in movement or screwing movement or generally distinguishes a plug-in axis and/or a rotational axis. For example, the sealing ring is an O-ring. Therefore, a standardized sealing ring can be used. An O-ring is advantageous in order, on the one hand, to make available sufficient freedom for carrying out the relative movement when coupling or uncoupling and, on the other hand, to achieve a required seal.

In one advantageous refinement there is provision that the seal surrounds a direction which is distinguished by the relative movement. The direction which is distinguished by the relative movement can be, for example, a plug-in axis and/or a rotational axis. It is particularly favorable here if the seal is of planar design, that is to say runs completely in one plane.

In one advantageous refinement there is provision that the sensor signal-processing device is configured to permanently store a multiplicity of measured values, recorded at predetermined times with the at least one measuring sensor, in a storage device. Therefore, the data logger is able to record measurement signals at predetermined times over a prescribed time period, with the result that the profile of the measured or monitored physical variable can be read out.

In one advantageous refinement there is provision that a coupling part of the coupling is formed on the battery housing part, and a matching mating coupling part of the coupling is formed on the electronic housing part. Therefore, additional parts for forming the coupling can be dispensed with. The coupling is therefore easy to construct and easy to couple or uncouple. In this context it is particularly favorable if the coupling and uncoupling can be executed by the relative movement already described.

In one advantageous refinement there is provision that the battery housing part is embodied in one piece. Therefore, a housing part which is easy to manufacture is described. It is particularly favorable if the battery housing part is embodied with a rotationally symmetrical base shape. A single-piece housing part is therefore easy to fabricate. Points where deposits of soiling start can therefore easily be avoided. For example, the battery housing part can have a cylindrical base shape.

Alternatively or additionally there can be provision that the electronic housing part is embodied in one piece. A housing part which is easy to manufacture is therefore described. It is particularly favorable if the electronic housing part is embodied with a rotationally symmetrical base shape. Therefore, a single-piece housing part is easy to fabricate. Points where deposits of soiling start can therefore easily be avoided. For example, the electronic housing part can have a cylindrical base shape.

The invention will now be described in more detail on the basis of an exemplary embodiment, but is not limited to this exemplary embodiment. Further exemplary embodiments emerge from a combination of the features of individual claims or multiple claims with one another and/or with individual or multiple features of the exemplary embodiment.

### BRIEF DESCRIPTION OF THE DRAWINGS

In the drawings, in highly simplified sectional illustrations,

FIG. 1 shows a data logger according to the invention in which the electronic part is disconnected from the battery part, and

FIG. 2 shows the data logger according to FIG. 1, wherein the battery part is coupled in the electronic part.

### DETAILED DESCRIPTION OF THE PREFERRED EMBODIMENT(S)

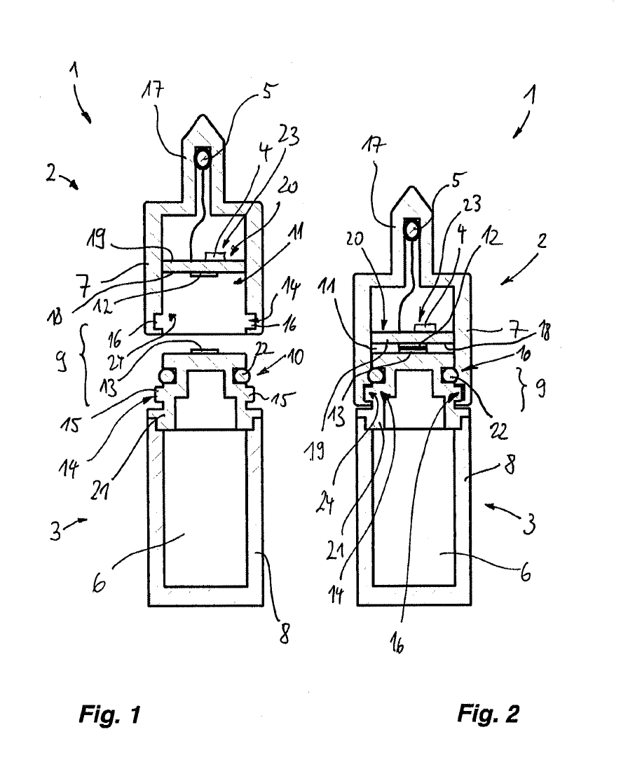

FIGS. 1 and 2 each show longitudinal sectional illustrations of a data logger 1 according to the invention. A common description of the figures is given below. In the presentation, details which are known to a person skilled in respect of the configuration of a data logger have been intentionally omitted. FIGS. 1 and 2 therefore show only the details which are necessary to illustrate the invention, in an otherwise highly simplified basic illustration.

The data logger 1 according to the invention has an electronic part 2 and a battery part 3 which are disconnected from one another in FIG. 1 and connected to one another in FIG. 2.

A sensor signal-processing device 4 which is configured in a manner known per se to evaluate and process a sensor signal of at least one measuring sensor 5 is arranged in the electronic part 2.

The battery part 3 has a battery 6 which is known per se and with which the sensor signal-processing device 4 can be supplied. Depending on the configuration of the measuring sensor 5, the battery can also be used to supply the measuring sensor 5.

The electronic part 2 is arranged here in an electronic housing part 7, while the battery part 3 is arranged in a battery housing part 8.

A coupling 9 with which the battery housing part 8 can be detachably connected to the electronic housing part 7 is formed at the interface between the electronic housing part 7 and the battery housing part 8. A seal 10, which in the coupled state provides a seal with respect to the outside according to FIG. 2, is formed on the coupling 9.

In the coupled state according to FIG. 2, the electronic housing part 7 and the battery housing part 8 enclose a contact region 11 in which contacts 12 of the electronic part 2 and mating contacts 13 of the battery part 3 are arranged.

The mating contacts 13 are embodied in a way corresponding to the contacts 12, with the result that in the coupled state according to FIG. 2 an electrical connection is established between the battery 6 and the sensor signal-processing device 4 and, if appropriate, the measuring sensor 5. For this purpose, the contacts 12 are connected to the sensor signal-processing device 4 and, if appropriate, to the measuring sensor 5, while the mating contacts 13 are connected to the battery 6.

From FIGS. 1 and 2 it is apparent that in the coupled state according to FIG. 2 the contact region 11 is closed off in a sealed fashion with respect to the outside by the seal 10, while in the coupled state of the coupling 9 the contacts 12 are electrically disconnected from the mating contacts 13.

The coupling of the electronic housing part 7 to the battery housing part 8 is carried out by a relative movement of the housing parts with respect to one another. In the present exemplary embodiment, the coupling 9 defines a bayonet coupling which has a guide 14 in the form of a guide pin 15 which engages in a corresponding guide groove 16. The relative movement, which in the present case is a plug-in-turning movement is therefore defined by this guide 14.

In a manner known per se from bayonet closures, in the coupled state according to FIG. 2 the coupling 9 is therefore secured mechanically against unintentional opening.

In a further exemplary embodiment, instead of the bayonet closure or in addition thereto the coupling 9 is embodied as a magnetic coupling in order to secure against unintentional opening.

The contacts 12 and the corresponding mating contacts 13 are arranged symmetrically about a plug-in axis and/or rotational axis which is predefined and distinguished with respect to coupling by the relative movement. This ensures that the formation of contact can be established in a plurality of orientations of the battery part 3 with respect to the electronic part 2.

A sensor tip 17, in which the at least one measuring sensor 5 is arranged, is formed on the electronic housing part 7, at an end facing away from the coupling 9. The measuring sensor here can be a temperature sensor which permits hermetic sealing of the sensor tip 17. Alternatively or additionally, the at least one measuring sensor 5 can also have a pressure sensor, in which case the sensor tip 17 can be configured with access openings (not illustrated further) for the application of the external pressure to the pressure sensor.

The contacts 12 are formed on the underside 18 of a printed circuit board 19. The printed circuit board 19 supports, on its upper side 20, the sensor signal-processing device 4, therefore also in such a way that it is protected in the uncoupled state.

The battery 6 is encapsulated in the battery housing part 8 in a hermetically sealed fashion. In this context, the coupling 9 has a coupling part 21 which is inserted into the battery housing part 8 and is connected thereto in a materially joined fashion.

The battery housing part 8 and the coupling part 21 are fabricated here from plastic in order to be able to establish a materially joined connection particularly easily. The battery part 3 is therefore embodied as a disposable part.

The electronic housing part 7 is manufactured from metal in one piece with the sensor tip 17, with the result that corresponding robustness in the case of re-use can be achieved.

The seal 10 is preferably a planar sealing ring 22 which is embodied as an O-ring and is therefore arranged in one plane.

It can generally be stated that the data logger 1 is configured to record measured values of the at least one measuring sensor 5 in a manner known per se. For this purpose, the sensor signal-processing device 4 can be configured, in a manner known per se, to permanently store a multiplicity of measured values which are recorded at previously determined times with the at least one measuring sensor 5, in an electronic storage device 23 which can be arranged or embodied in the sensor signal-processing device 4. A mating coupling part 24 is formed on the inner side of the electronic housing part 7, in particular by the guide grooves 16. The mating coupling part 24 is formed in one piece on the electronic housing part 7 and interacts with the coupling part 21 to form the coupling 9.

In respect of the data logger 1 it is provided to detachably couple an electronic housing part 7, which accommodates an electronic part 2 embodied with a sensor signal-processing device 4 and at least one measuring sensor 5, to a battery housing part 8, which accommodates a battery 6 for supplying the sensor signal-processing device 4, wherein in the coupled state an electrical connection is established between the battery 6 and the sensor signal-processing device 4 via contacts 12 and corresponding mating contacts 13, and is disconnected in the uncoupled state, and wherein in the coupled state a seal 10 on the coupling 9 protects the contacts 12 and the mating contacts 13 with respect to the outside.

### LIST OF REFERENCE NUMBERS

1 DATA LOGGER

2 Electronic part

3 Battery part

4 Sensor signal-processing device

5 Measuring sensor

6 Battery

7 Electronic housing part

8 Battery housing part

9 Coupling

10 Seal

11 Contact region

12 Contacts

13 Mating contacts

14 Guide

15 Guide pin

16 Guide groove

17 Sensor tip

18 Underside

19 Printed circuit board

20 Upper side

21 Coupling part

22 Sealing ring

23 Storage device

24 Mating coupling part

1. A data logger (1) comprising an electronic part (2) and a battery part (3), the electronic part (2) has a sensor signal-processing device (4) and a measuring sensor (5) connected thereto, and the battery part (3) has a battery (6) for supplying at least the sensor signal-processing device (4), the electronic part (2) is arranged in an electronic housing part (7), and the battery part (3) is arranged in a battery housing part (8), and the battery housing part (8) is detachably connectable to the electronic housing part (7) via a coupling (9), a seal (10) on the coupling (9) seals a contact region (11) with respect to outside for contacts (12) of the electronic part (2) and corresponding mating contacts (13) of the battery part (3) in the coupled state of the coupling (9), and in an uncoupled state of the coupling (9) the contacts (12) are electrically isolated from the corresponding mating contacts (13).

2. The data logger (1) as claimed in claim 1, wherein the coupling (9) is at least one of coupled or uncoupled by a relative movement of the electronic housing part (7) with respect to the battery housing part (8).

3. The data logger (1) as claimed in claim 1, wherein the coupling (9) has a guide that defines the relative movement.

4. The data logger (1) as claimed in claim 1, wherein the relative movement is a turning movement, plug-in movement, screwing movement or plug-in and turning movement.

5. The data logger (1) as claimed in claim 1, wherein in the coupled state the coupling (9) is secured against unintentional opening.

6. The data logger (1) as claimed in claim 5, wherein the coupling (9) is at least one of a bayonet closure or embodied as a magnetic coupling.

7. The data logger (1) as claimed in claim 1, wherein at least one of the contacts (12) or the corresponding mating contacts (13) are embodied symmetrically in such a way that there is electrical contact at least one of over a section of the relative movement or in a plurality of orientations of the electronic housing part (7) with respect to the battery housing part (8).

8. The data logger (1) as claimed in claim 1, wherein a sensor tip (17) is formed on the electronic housing part (7), and the at least one measuring sensor (5) is arranged in said sensor tip (17).

9. The data logger (1) as claimed in claim 1, wherein the measuring sensor (5) is at least ne of a temperature sensor or a pressure sensor.

10. The data logger (1) as claimed in claim 1, wherein the contacts (12) are arranged on an underside (18) of a printed circuit board (19) which is inserted into the electronic housing part (7).

11. The data logger (1) as claimed in claim 10, wherein the sensor signal-processing device (4) is arranged on an upper side (20) of the printed circuit board (19).

12. The data logger (1) as claimed in claim 1, wherein the battery (6) is arranged in the battery housing part (8) and encapsulated by a coupling part (21) of the coupling (9) in such a way that it is inaccessible with respect to the outside.

13. The data logger (1) as claimed in claim 1, wherein in the coupled state, the electronic housing part (7) and the battery housing part (8) at least encapsulate the sensor signal-processing device (4).

14. The data logger (1) as claimed in claim 1, wherein at least one of (a) the electronic housing part (7) is fabricated from metal, or (b) the battery housing part (8) is fabricated from plastic.

15. The data logger (1) as claimed in claim 1, wherein the seal (10) comprises a sealing ring (22).

16. The data logger (1) as claimed in claim 15, wherein the seal is an O-ring.

17. The data logger (1) as claimed in claim 1, wherein the seal (10) surrounds a direction which is distinguished by the relative movement.

18. The data logger (1) as claimed in claim 1, wherein the sensor signal-processing device (4) is configured to permanently store a multiplicity of measured values, recorded at predetermined times with the at least one measuring sensor (5), in a storage device (23).

19. The data logger (1) as claimed in claim 1, wherein a coupling part (21) of the coupling (9) is formed on the battery housing part (8), and a matching mating coupling part (24) of the coupling (9) is formed on the electronic housing part (7).

20. The data logger (1) as claimed in claim 1, wherein at least one of the battery housing part (8) or the electronic housing part (7) is embodied in one piece with a rotationally symmetrical base shape.
